(19) United States
(12) Patent Application Publication
(10) Pub. No.: US 2018/0060484 A1
(43) Pub. Date: Mar. 1, 2018

(54) EXTENDING ASSEMBLY CONTIGS BY ANALYZING LOCAL ASSEMBLY SUB-GRAPH TOPOLOGY AND CONNECTIONS

(71) Applicant: Pacific Biosciences of California, Inc., Menlo Park, CA (US)

(72) Inventor: Chen-Shan Chin, San Leandro, CA (US)

(21) Appl. No.: 15/682,142

(22) Filed: Aug. 21, 2017

Related U.S. Application Data
(60) Provisional application No. 62/378,579, filed on Aug. 23, 2016.

(51) Int. Cl. G06F 19/26; G06F 19/28; G06F 17/30; G06F 19/18

(52) U.S. Cl. CPC G06F 19/26; G06F 19/18; G06F 17/30958; G06F 19/28

(57) ABSTRACT

Aspects of the present disclosure provide methods, systems, and computer program products for generating one or more extended contigs. Aspects of the exemplary embodiment include receiving input contigs for a genome; generating local assembly subgraphs including the ends of each contig; identifying subgraphs that unambiguously connect two contigs; and generating an extended contig in which the orientation and order of at least two contigs is determined. Extended contigs can include any number of linearly ordered and linked contigs.

### CROSS-REFERENCE TO RELATED APPLICATIONS

This application is a non-provisional utility patent application claiming priority to and benefit of U.S. Provisional Patent Application No. 62/378,579, filed Aug. 23, 2016, the full disclosure of which is incorporated herein by reference in its entirety for all purposes.

### BACKGROUND OF THE INVENTION

In most overlap-layout-consensus methods for genome assembly from sequencing read datasets, contigs are broken at points where either there is no overlap found (i.e., there is no sequence read that overlaps and extends a terminus of a contig) or there is ambiguity on extending the contigs locally (i.e., there is more than one outlet path from a contig terminus). Certain ambiguities can be resolved, e.g., an ambiguity caused by a structural variation in the genome that results in relatively short parallel paths between two contigs (sometimes referred to as a bubble region). These relatively simple ambiguities can occur in diploid samples where such bubbles represent regions in which the homologous templates comprise sequence differences, e.g., SNPs, structural variations, mutations, etc. For a description of resolving such relatively short ambiguities, see US patent application publications 2015/0169823 and 2015/0286775 both entitled “String Graph Assembly for Polyploid Genomes”, both of which are hereby incorporated by reference herein in their entirety for all purposes.

However, many ambiguities in contig formation are caused by the presence of repeat sequences in the genome, resulting in unresolvable local assemblies that terminate a contig during the assembly process. These problematic repeat sequences include those caused by local repeats that occur within a single genomic region that is longer than the length of the reads used for producing the local assembly. Accordingly, there is a need for improved methods for determining the structural relationship between contigs separated by ambiguous repeat regions.

### BRIEF SUMMARY OF THE INVENTION

The present invention is generally directed to methods and systems for generating one or more extended contigs. Aspects of the exemplary embodiment include receiving input contigs for a genome; generating local assembly subgraphs from the ends of each contig; identifying subgraphs that unambiguously connect two contigs; and generating an extended contig in which the orientation and order of at least two contigs is determined.

The invention and various specific aspects and embodiments will be better understood with reference to the following detailed descriptions and figures, in which the invention is described in terms of various specific aspects and embodiments. These are provided for purposes of clarity and should not be taken to limit the invention. The invention and aspects thereof may have applications to a variety of types of methods, devices, and systems not specifically disclosed herein.

Aspects of the present disclosure include the following embodiments:

1. A method, executed by at least one software component on at least one processor, for producing an extended contig assembly comprising: (a) receiving a contig assembly graph comprising two or more contigs; (b) selecting one or more nodes in the contig assembly graph, wherein the one or more nodes are selected from: nodes corresponding to the end of a contig, nodes present in non-contig-associated regions, nodes at or near ambiguous regions inside a contig, and combinations thereof; (c) obtaining at least one local assembly subgraph comprising sequence reads within a defined distance of the one or more selected nodes; (d) identifying a local assembly subgraph that is connected to only two contigs in the contig assembly graph; and (e) outputting an extended contig assembly graph in which the two contigs are connected.

2. The method of embodiment 1, wherein the at least one local assembly subgraph is generated by the processor using a local assembly subgraph generator.

3. The method of embodiment 1, wherein the at least one local assembly subgraph is retrieved from a database.

4. The method of any one of embodiments 1 to 3, wherein identifying a local assembly subgraph that is connected to only two contigs in the contig assembly graph further comprises: characterizing one or more properties of the local assembly subgraph selected from the group consisting of: general complexity measurement of the branching structure inside the local assembly subgraph, the ratio of the number of edges or nodes to the distance from the one or more selected nodes, the number of nodes that connect to other parts of the contig assembly graph, and the contigs that the local assembly subgraph overlaps with.

5. The method of any one of embodiments 1 to 4, wherein a plurality of different local assembly subgraphs are obtained, each of which is initiated from a different selected node or set of nodes.

6. The method of embodiment 5, further comprising combining two or more of the plurality of different local assembly subgraphs that comprise overlapping regions.

7. The method of any one of embodiments 1 to 6, wherein the extended contig assembly graph further comprises the local assembly subgraph that connects the two contigs.

8. The method of any one of embodiments 1 to 7, wherein the extended contig assembly graph comprises a plurality of contigs connected linearly.

9. The method of embodiment 8, wherein the extended contig assembly graph further comprises the local assembly subgraphs that connects each of the linearly connected contigs.

10. The method of any one of embodiments 1 to 9, wherein the defined distance from the one or more selected nodes is: (a) up to 1,000 bases, 5,000 bases, 10,000 bases, 20,000 bases, 50,000 bases, 100,000 bases, 200,000 bases, 500,000 bases, or up to 1,000,000 bases; or (b) up to 10 edges, 20 edges, 30 edges, 40 edges, 50 edges, 60 edges, 100 edges, or up to 200 or more edges.

11. The method of any one of embodiments 1 to 10, wherein when the local assembly subgraph is not connected to only two contigs in the contig assembly graph, the defined distance is increased, a subsequent local assembly subgraph is obtained based on this increased distance, and steps (d) and (e) are repeated.

12. The method of embodiment 11, wherein the defined distance is iteratively increased until: (i) a subsequent local assembly subgraph is identified that unambiguously connects two contigs, or (ii) a maximum defined distance value is reached.

13. The method of embodiment 12, wherein the maximum defined distance is in the range of 1,000 bases to 1,000,000 bases or 10 edges to 200 edges.

14. The method of any one of embodiments 1 to 13, wherein additional genetic linkage data is employed in generating the extended contig.

15. The method of embodiment 14, wherein the additional genetic linkage data employed to resolve one or more areas of ambiguity and/or reduce the complexity of the subgraph and/or used to aid in orienting and ordering contigs.

16. The method of embodiments 14 or 15, wherein the additional genetic linkage data is selected from the group consisting of: optical mapping data, chromosome conformation capture (3C), Hi-C scaffolding, 3C-seq, Chicago, and combinations thereof.

17. An executable software product stored on a computer-readable medium containing program instructions for producing an extended contig assembly as in any one of embodiments 1 to 16.

18. A system for producing an extended contig assembly, comprising: a memory;

an input/output module; and a processor coupled to the memory and input/output module configured to: (a) receive a contig assembly graph comprising two or more contigs;

(b) select one or more nodes in the contig assembly graph, wherein the one or more nodes are selected from: nodes corresponding to the end of a contig, nodes present in non-contig-associated regions, nodes at or near ambiguous regions inside a contig, and combinations thereof; (c) obtain at least one local assembly subgraph comprising sequence reads within a defined distance of the one or more selected nodes; (d) identify a local assembly subgraph that is connected to only two contigs in the contig assembly graph; and (e) output an extended contig assembly graph in which the two contigs are connected.

19. The system of embodiment 18, further comprising a data repository.

20. The system of embodiment 19, wherein the data repository comprises a database selected from the group consisting of: sequence reads, aligned sequences, string graphs, unitig graphs, contigs, local assembly subgraphs, extended contig assemblies, and combinations thereof.

21. The system of any one of embodiments 20, further configured to retrieve the local assembly subgraph from the local assembly subgraphs database.

22. The system of any one of embodiments 18 to 21, wherein the memory comprises a processor-executable program selected from the group consisting of: a local assembly subgraph generator, a local assembly subgraph analyzer, an extended contig generator, and combinations thereof.

23. The system of embodiment 22, further configured to generate the local assembly subgraph using the local assembly subgraph generator.

24.The system of any one of embodiments 18 to 23, further configured to characterize one or more properties of the local assembly subgraph selected from the group consisting of: general complexity measurement of the branching structure inside the local assembly subgraph, the ratio of the number of edges or nodes to the distance from the one or more selected nodes, the number of nodes that connect to other parts of the contig assembly graph, and the contigs that the local assembly subgraph overlaps with.

25. The system of any one of embodiments 18 to 24, further configured to obtain a plurality of different local assembly subgraphs, each of which is initiated from a different selected node or set of nodes.

26. The system of any one of embodiments 18 to 25, further configured to combine two or more of the plurality of different local assembly subgraphs that comprise overlapping regions.

27. The system of any one of embodiments 18 to 26, further configured to output each local assembly subgraph that connects the two contigs in the extended contig assembly graph.

28. The system of any one of embodiments 18 to 27, wherein when the local assembly subgraph is not connected to only two contigs in the contig assembly graph, the system is further configured to increase the defined distance, obtain a subsequent local assembly subgraph based on this increased distance, and repeat steps (d) and (e).

29. The system of embodiment 28, further configured to iteratively increase the defined distance until: (i) a subsequent local assembly subgraph is identified that unambiguously connects two contigs, or (ii) a maximum defined distance value is reached.

30. The system of embodiment 29, wherein the maximum defined distance is in the range of 1,000 bases to 1,000,000 bases or 10 edges to 200 edges.

### BRIEF DESCRIPTION OF SEVERAL VIEWS OF THE DRAWINGS

FIG. 1 is a diagram illustrating one embodiment of a computer system for implementing a process for using a string graph to assemble a diploid or polyploid genome.

FIG. 2 is a flow diagram illustrating a process for extended contig assembly according to an exemplary embodiment.

FIGS. 3A and 3B are diagrams illustrating examples of methods for creating a string graph from overlaps between aligned sequences and an algorithm for transitive reduction.

FIGS. 4A and 4B are diagrams illustrating aspects of a local assembly subgraph that links contigs into an extended contig.

FIG. 5 is an example of a graph plotting graph complexity versus the ratio of the number of edges to the chosen distance D to find candidate contigs to connect into an extended contig.

### DETAILED DESCRIPTION OF THE INVENTION

As noted above, many ambiguities in contig formation are caused by the presence of repeat sequences in the genome, resulting in unresolvable local assemblies that terminate a contig during the assembly process. These problematic repeat sequences may be: (a) local repeats that occur within a single genomic region that is longer than the length of the reads used for producing the local assembly, or (b) distal repeats that occur at multiple non-local regions across the genome (e.g., on different chromosomes).

As described in detail herein, aspects of the present disclosure provide methods, performed by at least one software component executed on a processor, for connecting contigs across break points caused by local repeat sequences in the genome (item (a) above). The methods include analyzing one or more local assembly subgraphs extending from contig termini to understand the nature of the local repeat and find unique pairs of contigs that are connected through the repeats. By employing the methods described herein, two or more contigs can be connected linearly into a “scaffold” of contigs without addition long range data (also referred to herein as an “extended contig”). In addition, the methods disclosed herein provide a map of the genomic sequences and repeat structures between each pair of contigs in the extended contig, information that is not easily obtained using other sources of long-range data employed to generate genomic scaffolds for contigs analysis.

Various embodiments and components of the present invention employ signal and data analysis techniques that are familiar in a number of technical fields. For clarity of description, details of known analysis techniques are not provided herein. These techniques are discussed in a number of available reference works, such as: R. B. Ash. Real Analysis and Probability. Academic Press, New York, 1972; D. T. Bertsekas and J. N. Tsitsiklis. Introduction to Probability. 2002; K. L. Chung. Markov Chains with Stationary Transition Probabilities, 1967; W. B. Davenport and W. L Root. An Introduction to the Theory of Random Signals and Noise. McGraw-Hill, New York, 1958; S. M. Kay, Fundamentals of Statistical Processing, Vols. 1-2, (Hardcover—1998); Monsoon H. Hayes, Statistical Digital Signal Processing and Modeling, 1996; Introduction to Statistical Signal Processing by R. M. Gray and L. D. Davisson; Modern Spectral Estimation: Theory and Application/Book and Disk (Prentice-Hall Signal Processing Series) by Steven M. Kay (Hardcover—January 1988); Modern Spectral Estimation: Theory and Application by Steven M. Kay (Paperback—March 1999); Spectral Analysis and Filter Theory in Applied Geophysics by Burkhard Buttkus (Hardcover—May 11, 2000); Spectral Analysis for Physical Applications by Donald B. Percival and Andrew T. Walden (Paperback—Jun. 25, 1993); Astronomical Image and Data Analysis (Astronomy and Astrophysics Library) by J. L. Starck and F. Murtagh (Hardcover—Sep. 25, 2006); Spectral Techniques In Proteomics by Daniel S. Sem (Hardcover—Mar. 30, 2007); Exploration and Analysis of DNA Microarray and Protein Array Data (Wiley Series in Probability and Statistics) by Dhammika Amaratunga and Javier Cabrera (Hardcover—Oct. 21, 2003).

It is noted here that while the present disclosure can employ any convenient sequence assembly algorithm/process for generating the various maps (e.g., local sequence assemblies, contigs, etc.), many of the embodiments described herein use string graphs. An example of string graph construction can be found in Myers, E. W. (2005) Bioinformatics 21, suppl. 2, pgs. ii79-ii85; and US patent application publications 2015/0169823 and 2015/0286775 both entitled “String Graph Assembly for Polyploid Genomes”, all of which are hereby incorporated by reference herein in their entirety for all purposes.

### Definitions

By “contig” is meant a contiguous segment of the genome made by joining overlapping clones or sequences. A clone contig consists of a group of cloned (copied) pieces of DNA representing overlapping regions of a particular chromosome. A sequence contig is an extended sequence created by merging primary sequences that overlap. A contig map shows the regions of a chromosome where contiguous DNA segments overlap. Contig maps provide the ability to study a complete and often large segment of the genome by examining a series of overlapping clones, which then provide an unbroken succession of information about that region.

By “supercontig” or “scaffold” is meant an association made between two contigs, or a linear series of multiple contigs, that have no sequence overlap. This commonly occurs using information obtained from paired plasmid ends. For example, both ends of a BAC clone are sequenced. It can be inferred that these two sequences are approximately 150-200 Kb apart (based on the average size of a BAC). If the sequence from one end is found in a particular sequence contig, and the sequence from the other end is found in a different sequence contig, the two sequence contigs are said to be linked. In general, it is useful to have end sequences from more than one clone to provide evidence for linkage.

By “extended contig” is meant an association made between two contigs, or a linear series of multiple contigs, that have an ambiguous joining sequence between them (e.g., an ambiguous local sequence assembly). As described herein, an extended contig is formed between two distinct contigs when only these two contigs are connected to a single local subgraph assembly unambiguously. Thus, an extended contig contains a set of two or more contigs for which the order and orientation are known based on analysis of the local assembly subgraphs between them. Extended contigs can also include the sequence information between connected contigs. However, while extended contigs are localized nearby each other in the genome, the precise path or sequence between the ends of the two connected contigs might not be able to be determined definitively. For example, there could be multiple paths through a local assembly subgraph that connect a first contig to a second contig. Nonetheless, in some cases it is valuable to capture the DNA sequences/multiple different paths between the contigs as such information may find use in further analyses to reveal biological function of the elements in the region and/or determine a range of genomic distances that separate the two connected contigs.

By “assembly graph” is meant a graph data structure derived from sequence read overlapping information. One non-limiting example includes a string graph (see Myers, E. W. (2005) Bioinformatics 21, suppl. 2, pgs. ii79-ii85, which is incorporated herein by reference in its entirety for all purposes).

By “local assembly subgraph” is meant an assembly graph generated at a specified distance (D) from a specific location in a genomic map of interest, e.g., a node at the end (or breakpoint) of a contig.

### Computer Implemented Methods for Generating Extended Contigs

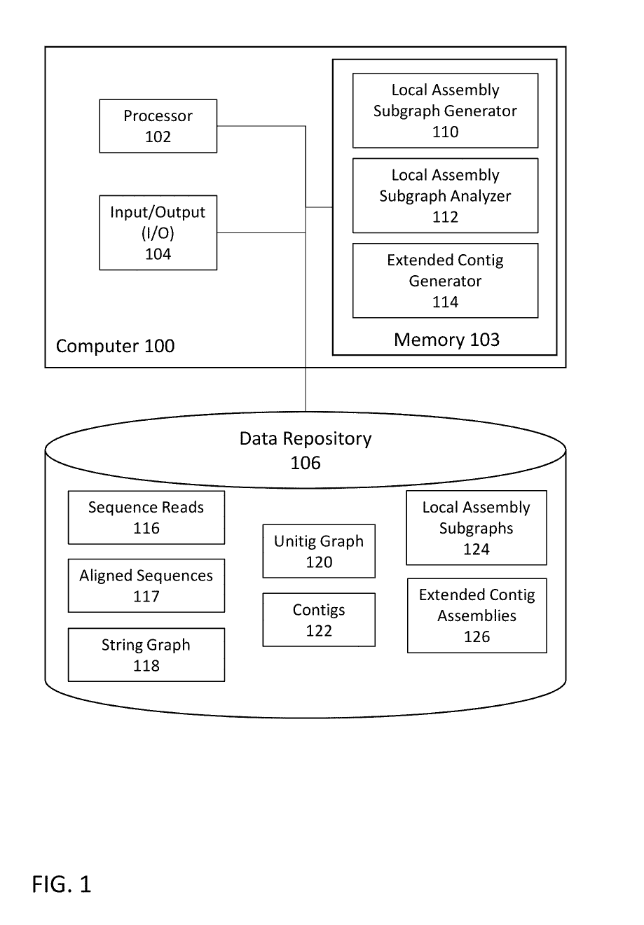

FIG. 1 is a diagram illustrating one embodiment of a computer system for implementing a process for generating extended contigs according to aspects of the present disclosure. In specific embodiments, the invention may be embodied in whole or in part as software recorded on fixed media. The computer 100 may be any electronic device having at least one processor 102 (e.g., CPU and the like), a memory 103, input/output (I/O) 104, and a data repository 106. The CPU 100, the memory 102, the I/O 104 and the data repository 106 may be connected via a system bus or buses, or alternatively using any type of communication connection. Although not shown, the computer 100 may also include a network interface for wired and/or wireless communication. In one embodiment, computer 100 may comprise a personal computer (e.g., desktop, laptop, tablet etc.), a server, a client computer, or wearable device. In another embodiment the computer 100 may comprise any type of information appliance for interacting with a remote data application, and could include such devices as an internet-enabled television, cell phone, and the like.

The processor 102 controls operation of the computer 100 and may read information (e.g., instructions and/or data) from the memory 103 and/or the data repository 106 and execute the instructions accordingly to implement the exemplary embodiments. The term processor 102 is intended to include one processor, multiple processors, or one or more processors with multiple cores.

The I/O 104 may include any type of input devices such as a keyboard, a mouse, a microphone, etc., and any type of output devices such as a monitor and a printer, for example. In an embodiment where the computer 100 comprises a server, the output devices may be coupled to a local client computer.

The memory 103 may comprise any type of static or dynamic memory, including flash memory, DRAM, SRAM, and the like. The memory 103 may store programs and data for performing the computational methods described herein including but not limited to a local assembly subgraph generator 110, a local assembly subgraph analyzer 112, and an extended contig generator 114. The memory may also store other programs not shown in FIG. 1, e.g., a string graph generator, a contig generator, a sequence aligner, etc. These components are used in the process of extended contig assembly as described herein. The memory may also store data (not shown).

The data repository 106 may store one or more databases, including but not limited to: one or more databases that store any one or combination of nucleic acid sequence reads (e.g., raw sequence reads, consensus sequence reads, etc.; hereinafter, “sequence reads”) 116, aligned sequences 117, string graphs 118, unitig graphs 120, contigs 122, local assembly subgraphs 124, and extended contig assemblies 126. Additional data, including additional types of genetic linkage data, may also be stored in the data repository 106 (not shown).

In one embodiment, the data repository 106 may reside within the computer 100. In another embodiment, the data repository 106 may be connected to the computer 100 via a network port or external drive. The data repository 106 may comprise a separate server or any type of memory storage device (e.g., a disk-type optical or magnetic media, solid state dynamic or static memory, and the like). The data repository 106 may optionally comprise multiple auxiliary memory devices, e.g., for separate storage of input sequences (e.g., sequence reads, reference sequences, etc.), sequence information, results of local assembly subgraph generation, results of extended contig generation, and/or other information. Computer 100 can thereafter use that information to direct server or client logic, as understood in the art, to embody aspects of the invention.

In operation, an operator may interact with the computer 100 via a user interface presented on a display screen (not shown) to specify parameters required by the various software programs. Once invoked, the programs in the memory 103 including the local assembly subgraph analyzer 112 and extended contig generator 114, are executed by the processor 102 to implement the methods of the present invention.

The local assembly subgraph analyzer 112 receives one or more local assembly subgraphs, e.g., generated by local assembly subgraph generator 110 or retrieved from the local assembly subgraph data 124 in the data repository 106. Each local assembly subgraph includes a node at or near the break point (or end) of at least one contig that is derived from a set of unconnected but related contigs, e.g., a set of unconnected contigs generated from genomic sequences. Each local assembly subgraph represents sequences that are within a predefined distance (or radius) from the node at the end of the contig (or from another specified node within an ambiguous region not assigned to a contig). Where string graph analyses are used, the distance can be defined as the number of edges from the selected node, and can include 10, 20, 30, 40, 50, 60, 100, or up to 200 or more edges from the selected node. In some embodiments, the distance is defined in terms of bases associated with the path between the nodes, e.g., 1,000, 5,000, 10,000, 20,000, 50,000, 100,000, 200,000, 500,000 or up to 1,000,000 bases from the selected node. Once the one or more local assembly subgraphs are received, the local assembly subgraph analyzer 112 determines, individually, whether each one is unambiguously connected to only two contigs in the set of related contigs from which the local assembly subgraph was generated. By “unambiguously connected to only two contigs in the contig assembly” is meant that based on the local assembly subgraph it is not possible for a third contig to be connected to the local assembly subgraph if the distance from the end node were to be expanded. If the local assembly subgraph cannot be unambiguously connected to only two contigs, the local assembly subgraph generator 112 can iteratively generate additional local assembly subgraphs from the same selected node (or nodes) using a higher distance/radius number. For example, if a local assembly subgraph generated using edges that are at a radius of 20 edges from an end node is not unambiguously connected to only two contigs, the local assembly graph generator can generate a local assembly subgraph using edges that are at a radius of 30 edges (or vertices) from the end node. This enlarged radius local assembly subgraph can then be analyzed by the local assembly subgraph analyzer to determine its contig connectivity. This process can be continued until either (1) a local assembly graph is generated that is unambiguously connected to two contigs, or (2) a maximum edge radius is reached. The maximum edge radius for a local assembly subgraph can be set internally or by a user and is meant to confine the analysis to local regions of ambiguity in a related set of contigs. This process is described in further detail below. In certain embodiments, the program(s) employed in implementing the methods are executed or accomplished using any appropriate implementation environment or programming language, including but not limited to: C, C++, C#, F#, Python, Python/C hybrid, Perl, Haskell, Scala, Lisp, Cobol, Pascal, Java, JavaScript, HTML, XML, dHTML, assembly or machine code programming, RTL, and/or others known in the art.

The progress and/or result of this processing may be saved to the memory 103 and/or the data repository 106 and/or output through the I/O 104 for display on a display device and/or saved to an additional storage device (e.g., CD, DVD, Blu-ray, flash memory card, etc.), or printed. The result of the processing may include one or more extended contig assemblies 126 and optionally potential sequence information for the region between each connected contig in the extended contig assembly (which is based on the local assembly subgraph connecting each contig). This information can be stored or displayed in whole or in part, as determined by the user/practitioner. The results may further comprise quality information, technology information (e.g., peak characteristics, expected error rates), alternate extended contig assemblies (e.g., based on different distance cut-offs for generating local subgraph assemblies), confidence metrics, and the like.

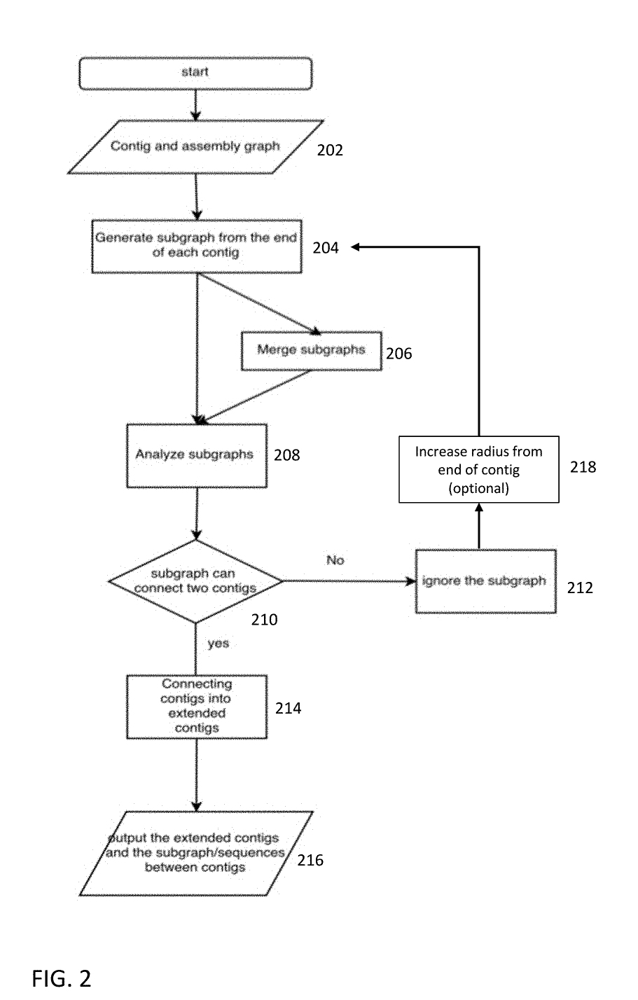

FIG. 2 is a flow diagram illustrating certain aspects of a process for extended contig assembly according to an exemplary embodiment. The process may be performed by the computer 114 executing the programs in the memory 103 using the processor 102. Information from a user and/or the data repository 106 may be accessed.

In FIG. 2, the process begins by the receiving contigs and associated assembly graph 202. The assembly graph is analyzed to identify and select one or more nodes in the graph that (i) correspond to the end of a contig, (ii) are present in non-contig associated regions (ambiguous regions), and/or (iii) are near ambiguous regions inside a contig. For the example shown in FIG. 2, the nodes are selected in to be at the ends of the contigs in the assembly.

In step 204, a local assembly subgraph is generated or is retrieved from a database (if previously generated) that includes sequence reads that are within a certain “distance” from each selected node. In this case, a local assembly subgraph from the end of each contig is generated (e.g., by the local assembly subgraph generator 110).

Once the local assembly subgraph for each selected node is generated (or retrieved), each one is analyzed to characterize various aspects of the properties of the subgraph 208. Examples of aspects include but are not limited to: (1) general complexity measurement of the branching structure inside the subgraph, (2) the ratio of the number of edges or nodes related the distance from the node(s) of interests, (3) the number of the nodes that connect to other parts of the whole assembly (of which the subgraph is a part) and (4) the contigs that the graph has overlapped with, etc.

In certain cases, two or more different local assembly subgraphs starting from different selected nodes might overlap with each other. In some of these cases, overlapping local assembly subgraphs are merged and analyzed as a single local assembly sub-graph 206.

After analyzing each subgraph (or merged subgraphs), if two distinct contigs are connected to the subgraph unambiguously (“yes” at 210), then these two contigs are localized nearby each other in the genome to form an extended contig 214. As defined above, an “extended contig” contains a set of contigs which the order and orientation are determined by the subgraphs between them. This extended contig can be output to a user, in some cases along with the intervening ambiguous region of the local assembly subgraph positioned between them 216. It is emphasized here that connecting two contigs into an extended contig does not imply that a single known sequence or path links them. Rather, the connection into an extended contig indicates that while there are still multiple possible sequences or paths between these contigs, it is highly likely that these contigs are genetically linked. It is still valuable to collect and provided to a user the map of each ambiguous region between connected contigs in an extended contig as analysis of this ambiguous region can provide a set of alternative paths and/or sequences between the connected contigs. Such information and analysis can be useful in revealing biological function of the elements in the region.

It is further noted that an extended contig can include any number of contigs connected by the subgraphs in between them. In such cases, the end of each contig in the extended contig can be connected to at most the end of one other contig. Thus, as described above, an extended contig provides a map of the order and orientation of contigs having ambiguous local assemblies between them that previously prevented them from being linked in the genome being analyzed.

Returning to decision point 210, if a local assembly subgraph does not unambiguously connect two contigs (e.g., it has only one contig inlet/outlet or has 3 or more contig inlets/outlets), then the subgraph is ignored and no connection is made 212. In certain embodiments, the radius (or distance) parameter used to generate the ignored local assembly subgraph is increased 218 and a subsequent local assembly subgraph is generated (or retrieved) from the same node (or contig end). This subsequent local assembly subgraph is analyzed as set forth above (entering at step 204). This process can be reiterated until (i) a subsequent local assembly subgraph is analyzed that unambiguously connects two contigs, or (ii) a maximum radius/distance value is reached. The maximum distance can be defined by a user or programmer. In certain embodiments, e.g., when string graph assemblies are employed, the maximum distance/radius can be defined as the number of edges from the selected node, e.g., 10, 20, 30, 40, 50, 60, 100, 200, 400, or 500 or more edges from the selected node. In some embodiments, the maximum distance is defined in terms of bases, e.g., 1,000, 5,000, 10,000, 20,000, 50,000, 100,000, 200,000, 500,000, or 1,000,000 or more bases from the selected node.

It is noted that while the subgraph analysis described herein finds use in connecting contigs into an extended contig, such subgraph analysis also finds use in identifying mis-assemblies or ambiguity of assembly contiguity within a contig.

The sections below are provided to exemplify certain aspects of the steps of extended contig generation described above. These descriptions are not meant to be limiting.

### Constructing Subgraph Start from Defined Node

In certain embodiments, local assembly subgraphs are generated using string graphs (see, e.g., Myers et al. 2005, cited above). A brief description of string graph generation is provided below.

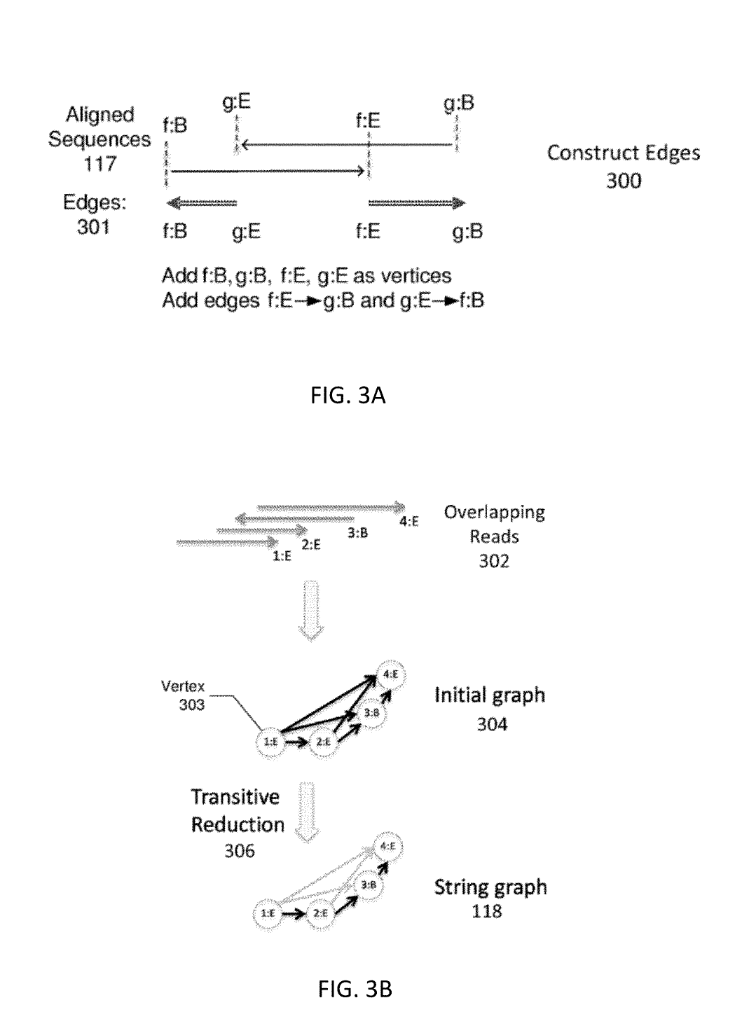

FIGS. 3A and 3B are diagrams illustrating embodiments of methods for creating a string graph from overlaps between aligned sequences and an algorithm for transitive reduction. As an overview, a string graph generator may generate the string graph 118 by constructing edges 300 from the aligned, overlapping sequences 117 based on where the reads overlap one another. The core of the string graph algorithm is to convert each “proper overlap” between two aligned sequences into a string graph structure. In FIG. 3A, two overlapping reads (aligned sequences 117) are provided to illustrate the concepts of vertices and edges with respect to overlapping reads. Specifically, the vertices right at the boundaries of an overlap are g:E and f:E are identified as the “in-vertices” of the new edges to be constructed. Edges 301 are generated by extending from the in-vertices to the ends of the non-overlapping parts of the aligned reads, which are identified as the “out-vertices,” e.g., f:E to g:B (out-vertex) and g:E to f:B (out-vertex). If the sequence direction is the same as the direction of the edges, the edge is labeled with the sequence as it is in the sequence read. If the sequence direction is opposite that of the direction of the edges, the edge is labeled with the reverse complement of the sequences.

In FIG. 3B, the four aligned, overlapping reads 302 are used to create an initial graph 304, and the initial graph 304 is subjected to transitive reduction 306 and graph reduction, e.g., by “best overlapping,” to generate the string graph 118. Detecting overlaps in the aligned sequences 117 (also referred to as overlapping reads) may be performed using overlap-detection code that functions quickly, e.g., using k-mer-based matching.

Converting the overlapping reads 302 into the initial graph 304 may comprise identifying vertices that are at the edges of an overlapping region and extending them to the ends of the non-overlapped parts of the overlapping fragments. Each of the edges (shown as the arrows in initial graph 304) is labeled depending on the direction of the sequence. Thereafter, redundant edges are removed by transitive reduction 306 to yield the string graph 118. Further details on string graph construction are provided in Myers, E. W. (2005) Bioinformatics 21, suppl. 2, pgs. ii79-ii85, which is incorporated herein by reference in its entirety for all purposes.

In many embodiments, the string graphs employed in the present invention are directed graph representations rather than bi-directional graph representations (although the method described herein can be used in both directed and bi-directional graph representations). Directed graphs are useful when the analysis begins at the end of a contig in which one direction from the node has already been analyzed and mapped (i.e., the direction back into the contig). It is the direction out from the contig (i.e., the area of ambiguity) that is mapped and analyzed.

A local assembly subgraph is constructed given a read identifier (e.g., one or more nodes or edges) and the pre-specified distance, e.g., 10, 20, 30, 40, 50, 60, 100, 200, 500 or more edges from the node. The subgraph is constructed by a breath first search starting at both 5′-end and 3′-end of the reads on both directions until the pre-specified distance is reached. For example, for a read R, there will be two nodes in the assembly graph denoted as R:B (5′-end) and R:E (3′-end). The subgraph we consider contains all the nodes that can connect to R:B and connect from R:B and all the nodes that can connect to R:E and connect from R:E with the pre-specified distance D and the edges between the selected nodes.

In current implementation, the distance between the nodes are defined as the number of edges of the shortest path between the nodes in the assembly graph. We can use an alternative definition where D is the number of base of the sequence of the shortest path measured by base pairs between the nodes (as noted above).

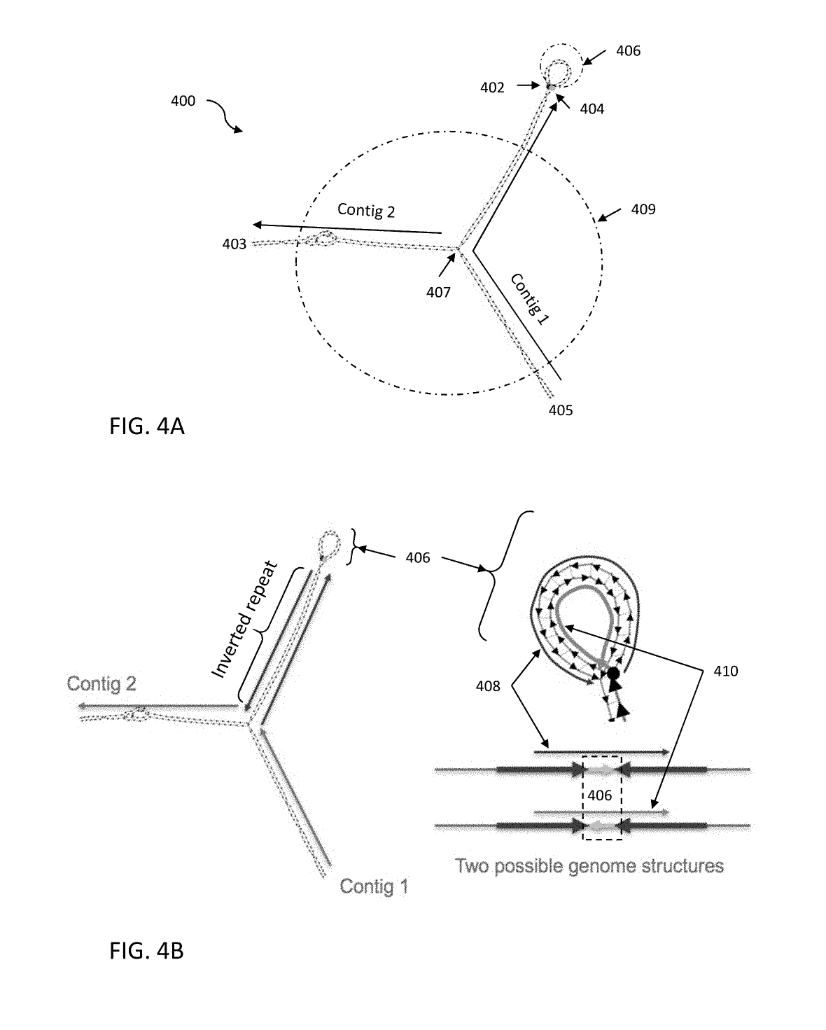

FIG. 4A shows a local assembly subgraph 400 generated according to aspects of the present disclosure in which D=60 (where D is defined in edges). The contig ends (or nodes) used as the seeding nodes for generating local assembly subgraph 400 are indicated as dots 402 and 404. The sequences assigned to contigs (Contig 1 and Contig 2) are indicated with arrows. A loop region 406 not assigned to any contig is shown in the dotted circle.

### Subgraph Analysis

The local assembly subgraph 400 can be analyzed using a complexity measurement as follows.

Let the total number of edges in a sub-graph be defined as N. The subgraph can be decomposed into some unbranched path. Assuming there are m such paths, and the length is Nᵢ for i-th path, the “entropy” of the graph is calculated as (a description of entropy can be found, e.g., in Dehmer and Mowshowitz, 2011, Information Science 181:57-78, hereby incorporated herein by reference in its entirety):

S=Σᵢpᵢlog pᵢ

where pᵢ=Nᵢ/N.

Assuming the graph is extended by a distance D and the number of edges (or nodes) in the subgraph is N, then the ratio of the number of edges or nodes related to the distance from the node of interest is calculated as N/D. When the number is close to two per DNA strand, the graph is likely more linear and connects two contigs.

In each local assembly subgraph analyzed, there will be nodes connecting to other nodes which are not in the local assembly subgraph, e.g., that connect to a node in a contigs of the input contig assembly. In the example shown in FIG. 4A, there are 4 nodes (two for each DNA strand direction) connecting to another part of the assembly graph (positions 403 and 405). If the numbers of connection per DNA strand to other part of the graph is 2, it is more likely the subgraph unambiguously connects two contigs. If the numbers of connection per DNA strand to other part of the graph is greater than 2, the local assembly subgraph cannot unambiguously be connected to two contigs.

For example, suppose the local assembly subgraph generated was centered around the node at position 407 in FIG. 4A (at the end of Contig 2) and had a radius defined as circle 409. This local subgraph assembly would have numbers of connection per DNA strand of 3: two connections at each place circle 409 intercepts Contig 1 and Contig 2 (note that the circle intercepts Contig 1 twice). This local assembly subgraph would be ignored and a new subgraph generated that had an increased radius until the connections per DNA strand was 2 (i.e., until the local assembly subgraph included the entirety of subgraph 400).

With respect to local assembly subgraph 400, the analysis described above would connect Contig 1 and 2 into an extended contig. Furthermore, an analysis of the graph structure indicates there is an invert repeat between the two contigs (shown in FIG. 4B, left panel) that is connected by loop sequence 406. This ambiguity between the contigs can be presented to a user as shown in FIG. 4B, right panel. Specifically, the genomic structure between contigs 1 and 2 include the inverted repeat separated by loop 406 in one of two orientations (indicated in the right panel by arrows 408 and 410).

In some embodiments, the ambiguous region between contigs in an extended contig are more complicated than that shown in FIG. 4B. Thus, these regions may have many different possible paths and sequences.

In certain embodiments, additional types of genetic linkage data (e.g., scaffolding data) can be used to refine the path in an extended contig assembly generated according to the methods described herein. For example, once a local assembly subgraph is obtained or generated, other independent data can be employed to resolve one or more areas of ambiguity and/or reduce the complexity of the subgraph. In other embodiments, additional types of genetic linkage data can be used to aid in orienting and ordering contigs in the method described herein. For example, if a local assembly subgraph is connected to more than two contigs, the additional data can be used to identify whether any of the contigs connected to the subgraph may map to a different genetic location (e.g., a different chromosome) and thus be unlikely to truly be connected to the local assembly subgraph. For example, multiple non-contiguous regions in a genome may be connected through a common repetitive element, e.g., a repetitive element present in different chromosomes, and the additional data may be able to rectify such ambiguities in sequence alignment. Examples of additional data include: optical mapping data, chromosome conformation capture (3C), Hi-C scaffolding, 3C-seq, Chicago, etc. (See, e.g., Zhou et al., 2007, A Single Molecule System for Whole Genome Analysis. New high throughput technologies for DNA sequencing and genomics. 2. Elsevier. pp. 269-304; Flot et al., 2015, Contact genomics: scaffolding and phasing(meta)genomes using chromosome 3D physical signatures. FEBS Letters 20:2966-2974; each of which is hereby incorporated herein by reference in its entirety).

### Constructing the Extended Contigs

As indicated above, construction of extended contigs begins with obtaining contigs from a genome (either generating the contigs, retrieving the contigs from a database, or a combination of both). Once obtained, local assembly subgraphs are generated that start with (or include) include nodes from (or seeds) from the ends of all contigs or selected contigs. Where local assembly subgraphs have overlapping sections, the can be merged (as noted above; see Flow Chart in FIG. 2). For each subgraph, its properties are analyzed and connections between contigs are made.

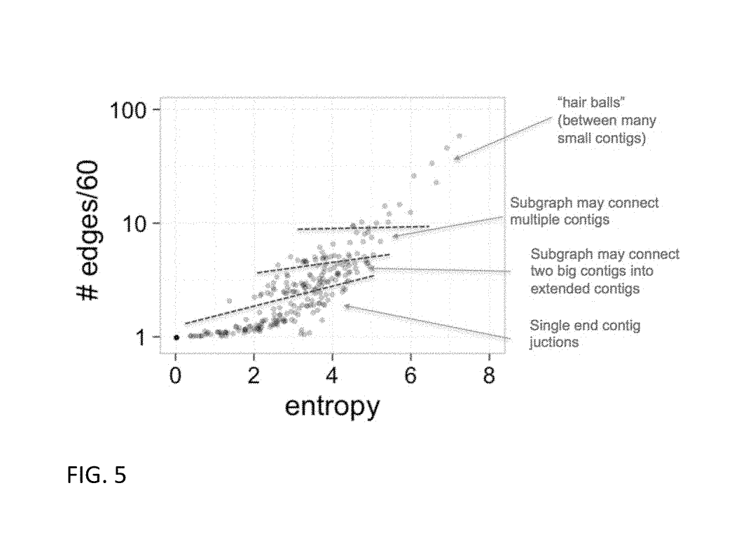

FIG. 5 shows an example using the graph complexity and the ratio of the number of edges to the chosen distance D (in this case 60) to find candidates that unambiguously connect two contigs. Each dot in the plot in FIG. 5 corresponds to one local assembly subgraph. In this plot, 4 different groups (or clusters) of subgraphs are observed: (1) single end contig junctions (i.e., subgraphs that are connected to only a single contig end); (2) subgraphs that may unambiguously connect two contigs into an extended contig; (3) subgraphs that may connect the ends of more than two contigs; and (4) subgraphs that include or connect many small contigs (sometimes referred to as “hair balls”). We can use this initial analysis to identify local assembly subgraph clusters to prioritize for subsequent analysis to verify that they connect two contigs unambiguously. The general concept is to analyze a certain subset of the matrices for the local assembly subgraphs generated for a contig assembly to build a classifier to predict the subgraphs of highest interests. It is possible (and sometimes likely) that one or more of the local assembly subgraphs generated for a contig assembly will not be resolvable (i.e., cannot unambiguously connect two contigs in the contig assembly) and we can predict them using such matrices. It is noted here that different aspects/matrices can be graphed and analyzed in this way to identify clusters of local assembly subgraphs that are likely include ones that unambiguously connect two contigs in a contig assembly (see, e.g., aspects (1) to (4) described above).

Connect all junctions between any two contigs where analysis of the local assembly subgraph shows an unambiguous linkage between them to generate an extended contig and output to a user. The potential sequence information between the connected contigs can also be output.

### Additional Aspects of Sequence Analysis

Any additional aspects of sequence acquisition and analysis that find use in supporting the present invention may be employed. The following is a brief discussion of examples of such additional aspects that are not meant to be limiting. Some of these additional aspects are described in: Myers, E. W. (2005) Bioinformatics 21, suppl. 2, pgs. ii79-ii85; and US patent application publications 2015/0169823 and 2015/0286775 both entitled “String Graph Assembly for Polyploid Genomes”, all of which are hereby incorporated by reference herein in their entirety for all purposes.

According to one aspect, the sequence reads used as input to generate contigs or local assemblies (e.g., string graphs) are considered long sequencing reads, ranging in length from about 1 kb, 5 kb, 10 kb, 20 kb, 50 kb, 100 kb, 200 kb, 500 kb, 1,000 kb. In preferred embodiments, these long sequencing reads are generated using a single polymerase enzyme polymerizing a nascent strand complementary to a single template molecule. For example, the long sequencing reads may be generated using Pacific Biosciences' single-molecule, real-time (SMRT®) sequencing technology. In one embodiment, the sequence reads may be generated using a single-molecule sequencing technology such that each read is derived from sequencing of a single template molecule. Single-molecule sequencing methods are known in the art, and preferred methods are provided in U.S. Pat. Nos. 7,315,019, 7,476,503, 7,056,661, 8,153,375, and 8,143,030; U.S. Ser. No. 12/635,618, filed Dec. 10, 2009; and U.S. Ser. No. 12/767,673, filed Apr. 26, 2010, all of which are incorporated herein by reference in their entirety for all purposes. In certain preferred embodiments, the technology used comprises a zero-mode waveguide (ZMW). In certain embodiments, the sequence reads are provided in a FASTA file.

Sequence reads from various kinds of biomolecules may be analyzed by the methods presented herein, e.g., polynucleotides and polypeptides. The biomolecule may be naturally-occurring or synthetic, and may comprise chemically and/or naturally modified units, e.g., acetylated amino acids, methylated nucleotides, etc. Methods for detecting such modified units are provided, e.g., in U.S. Ser. No. 12/635,618, filed Dec. 10, 2009; and Ser. No. 12/945,767, filed Nov. 12, 2010, which are incorporated herein by reference in their entireties for all purposes. In certain embodiments, the biomolecule is a nucleic acid, such as DNA, RNA, cDNA, or derivatives thereof. In some preferred embodiments, the biomolecule is a genomic DNA molecule. The biomolecule may be derived from any living or once living organism, including but not limited to prokaryote, eukaryote, plant, animal, and virus, as well as synthetic and/or recombinant biomolecules. Further, each read may also comprise information in addition to sequence data (e.g., base-calls), such as estimations of per-position accuracy, features of underlying sequencing technology output (e.g., trace characteristics (integrated counts per peak, shape/height/width of peaks, distance to neighboring peaks, characteristics of neighboring peaks), signal-to-noise ratios, power-to-noise ratio, background metrics, signal strength, reaction kinetics, etc.), and the like.

In one embodiment, the sequence reads 116 may be generated using essentially any technology capable of generating sequence data from biomolecules, e.g., Maxam-Gilbert sequencing, chain-termination methods, PCR-based methods, hybridization-based methods, ligase-based methods, microscopy-based techniques, sequencing-by-synthesis (e.g., pyrosequencing, SMRT® sequencing, SOLiD™ sequencing (Life Technologies), semiconductor sequencing (Ion Torrent Systems), tSMS™ sequencing (Helicos BioSciences), Illumina® sequencing (Illumina, Inc.), nanopore-based methods (e.g., BASE™, MinION™, STRAND™), etc.).

In certain embodiments, the sequence information analyzed may comprise replicate sequence information. Examples of methods of generating replicate sequence information from a single molecule are provided, e.g., in U.S. Pat. No. 7,476,503; U.S. Patent Publication No. 20090298075; U.S. Patent Publication No. 20100075309; U.S. Patent Publication No. 20100075327; U.S. Patent Publication No. 20100081143, U.S. Ser. No. 61/094,837, filed Sep. 5, 2008; and U.S. Ser. No. 61/099,696, filed Sep. 24, 2008, all of which are assigned to the assignee of the instant application and incorporated herein by reference in their entireties for all purposes.

In some embodiments, the accuracy of the sequence read data initially generated by a sequencing technology discussed above may be approximately 70%, 75%, 80%, 85%, 90%, or 95%. Since efficient string graph construction preferably uses high-accuracy sequence reads, e.g., preferably at least 98% accurate, where the sequence read data generated by a sequencing technology has a lower accuracy, the sequence read data may be subjected to further analysis, e.g., overlap detection, error correction etc., to provide the sequence reads 116 for use in the string graph generator 112. For example, the sequence read data can be subjected to a pre-assembly step to generate high-accuracy pre-assembled reads, as further described elsewhere herein.

For ease of discussion, various aspects of the invention will be described with regards to analysis of polynucleotide sequences, but it is understood that the methods and systems provided herein are not limited to use with polynucleotide sequence data and may be used with other types of sequence data, e.g., from polypeptide sequencing reactions.

In certain embodiments, sequence read data is used to create “pre-assembled reads” having sufficient quality/accuracy for use as sequence reads for generating a string graph (e.g., local assembly). A pre-assembly sequence aligner (which may also be referred to as an aggregator) may perform pre-assembly of the sequence read data, e.g., as described in detail in U.S. patent application Ser. No. 13/941,442, filed Jul. 12, 2013; 61/784,219, filed Mar. 14, 2013; and 61/671,554, filed Jul. 13, 2012, which are incorporated herein by reference in their entireties for all purposes.

Aspects of the disclosed methods include generating or retrieving contig graphs for a genome of interest. In certain embodiments, string graphs are used as the starting point for generating contigs. For example, non-branching unitigs within the string graph can be identified to form a unitig graph, where unitigs represent the contigs that can be constructed unambiguously from the string graph and that correspond to the linear paths in the string graph without any branch induced by repeats or sequencing errors. In certain embodiments, some relatively some simple branches in an assembly can be traversed to link unitigs, e.g., in haplotype analysis of known diploid genomes (see e.g., US patent application publications 2015/0169823 and 2015/0286775 both entitled “String Graph Assembly for Polyploid Genomes”, both of which are hereby incorporated by reference herein in their entirety for all purposes).

### Computer Implementation

In some embodiments, the system includes a computer-readable medium operatively coupled to the processor that stores instructions for execution by the processor. The instructions may include one or more of the following: instructions for receiving input of contigs, instructions for constructing local assembly subgraphs, instructions for merging subgraphs, instructions for analyzing local assembly subgraphs, instructions for connecting contigs to form extended contigs, instructions for iteratively increasing the radius of an ignored subgraph and re-generating a new subgraph based on the new radius and analyzing the new subgraph, instructions that compute/store information related to various steps of the method, instructions that record the results of the method, and instructions to output the extended contig and connecting subgraph to a user.

In certain aspects, the methods are computer-implemented methods. In certain aspects, the algorithm and/or results (e.g., extended contigs) are stored on computer-readable medium, and/or displayed on a screen or on a paper print-out. In certain aspects, the results are further analyzed, e.g., to identify genetic variants, to identify one or more origins of the sequence information, to identify genomic regions conserved between individuals or species, to determine relatedness between two individuals, to provide an individual with a diagnosis or prognosis, or to provide a health care professional with information useful for determining an appropriate therapeutic strategy for a patient. For example, the method can be used to identify structural chromosomal variations associated with a disease state in a patient, e.g., inversions, translocations, truncations, duplications, etc.

Furthermore, the functional aspects of the invention that are implemented on a computer or other logic processing systems or circuits, as will be understood to one of ordinary skill in the art, may be executed or accomplished using any appropriate implementation environment or programming language, including but not limited to: C, C++, C#, F#, Python, Python/C hybrid, Perl, Haskell, Scala, Lisp, Cobol, Pascal, Java, JavaScript, HTML, XML, dHTML, assembly or machine code programming, RTL, and/or others known in the art.

In certain embodiments, the computer-readable media may comprise any combination of a hard drive, auxiliary memory, external memory, server, database, portable memory device (CD-ft DVD, ZIP disk, flash memory cards, etc.), and the like.

In some aspects, the invention includes an article of manufacture for string graph assembly of polyploid genomes that includes a machine-readable medium containing one or more programs which when executed implement the steps of the invention as described herein.

It is to be understood that the above description is intended to be illustrative and not restrictive. It readily should be apparent to one skilled in the art that various modifications may be made to the invention disclosed in this application without departing from the scope and spirit of the invention. The scope of the invention should, therefore, be determined not with reference to the above description, but should instead be determined with reference to the appended claims, along with the full scope of equivalents to which such claims are entitled. Throughout the disclosure various references, patents, patent applications, and publications are cited. Unless otherwise indicated, each is hereby incorporated by reference in its entirety for all purposes. All publications mentioned herein are cited for the purpose of describing and disclosing reagents, methodologies and concepts that may be used in connection with the present invention. Nothing herein is to be construed as an admission that these references are prior art in relation to the inventions described herein.

1. A method, executed by at least one software component on at least one processor, for producing an extended contig assembly comprising:
(a) receiving a contig assembly graph comprising two or more contigs;
(b) selecting one or more nodes in the contig assembly graph, wherein the one or more nodes are selected from: nodes corresponding to the end of a contig, nodes present in non-contig-associated regions, nodes at or near ambiguous regions inside a contig, and combinations thereof;
(c) obtaining at least one local assembly subgraph comprising sequence reads within a defined distance of the one or more selected nodes;
(d) identifying a local assembly subgraph that is connected to only two contigs in the contig assembly graph; and
(e) outputting an extended contig assembly graph in which the two contigs are connected.

2. The method of claim 1, wherein the at least one local assembly subgraph is generated by the processor using a local assembly subgraph generator.

3. The method of claim 1, wherein the at least one local assembly subgraph is retrieved from a database.

4. The method of claim 1, wherein identifying a local assembly subgraph that is connected to only two contigs in the contig assembly graph further comprises: characterizing one or more properties of the local assembly subgraph selected from the group consisting of: general complexity measurement of the branching structure inside the local assembly subgraph, the ratio of the number of edges or nodes to the distance from the one or more selected nodes, the number of nodes that connect to other parts of the contig assembly graph, and the contigs that the local assembly subgraph overlaps with.

5. The method of claim 1, wherein a plurality of different local assembly subgraphs are obtained, each of which is initiated from a different selected node or set of nodes.

6. The method of claim 5, further comprising combining two or more of the plurality of different local assembly subgraphs that comprise overlapping regions.

7. The method of claim 1, wherein the extended contig assembly graph further comprises the local assembly subgraph that connects the two contigs.

8. The method of claim 1, wherein the extended contig assembly graph comprises a plurality of contigs connected linearly.

9. The method of claim 8, wherein the extended contig assembly graph further comprises the local assembly subgraphs that connects each of the linearly connected contigs.

10. The method of claim 1, wherein the defined distance from the one or more selected nodes is:
(a) up to 1,000 bases, 5,000 bases, 10,000 bases, 20,000 bases, 50,000 bases, 100,000 bases, 200,000 bases, 500,000 bases, or up to 1,000,000 bases; or
(b) up to 10 edges, 20 edges, 30 edges, 40 edges, 50 edges, 60 edges, 100 edges, or up to 200 or more edges.

11. The method of claim 1, wherein when the local assembly subgraph is not connected to only two contigs in the contig assembly graph, the defined distance is increased, a subsequent local assembly subgraph is obtained based on this increased distance, and steps (d) and (e) are repeated.

12. The method of claim 11, wherein the defined distance is iteratively increased until: (i) a subsequent local assembly subgraph is identified that unambiguously connects two contigs, or (ii) a maximum defined distance value is reached.

13. The method of claim 12, wherein the maximum defined distance is in the range of 1,000 bases to 1,000,000 bases or 10 edges to 200 edges.

14. The method of claim 1, wherein additional genetic linkage data is employed in generating the extended contig.

15. The method of claim 14, wherein the additional genetic linkage data employed to resolve one or more areas of ambiguity and/or reduce the complexity of the subgraph and/or used to aid in orienting and ordering contigs.

16. The method of claim 14, wherein the additional genetic linkage data is selected from the group consisting of: optical mapping data, chromosome conformation capture (3C), Hi-C scaffolding, 3C-seq, Chicago, and combinations thereof.

17. (canceled)

18. A system for producing an extended contig assembly, comprising:
a memory;
an input/output module; and
a processor coupled to the memory and input/output module configured to:
(a) receive a contig assembly graph comprising two or more contigs;
(b) select one or more nodes in the contig assembly graph, wherein the one or more nodes are selected from: nodes corresponding to the end of a contig, nodes present in non-contig-associated regions, nodes at or near ambiguous regions inside a contig, and combinations thereof;
(c) obtain at least one local assembly subgraph comprising sequence reads within a defined distance of the one or more selected nodes;
(d) identify a local assembly subgraph that is connected to only two contigs in the contig assembly graph; and
(e) output an extended contig assembly graph in which the two contigs are connected.

19. The system of claim 18, further comprising a data repository.

20. The system of claim 19, wherein the data repository comprises a database selected from the group consisting of: sequence reads, aligned sequences, string graphs, unitig graphs, contigs, local assembly subgraphs, extended contig assemblies, and combinations thereof.

21. The system of any one of claims 20, further configured to retrieve the local assembly subgraph from the local assembly subgraphs database.

22-30. (canceled)
